(19) United States
(12) Patent Application Publication
(10) Pub. No.: US 2014/0184154 A1
(43) Pub. Date: Jul. 3, 2014

(54) ELECTRONIC COMPONENT, POWER RECEIVING DEVICE, AND POWER FEEDING SYSTEM

(71) Applicant: SEIKO INSTRUMENTS INC., Chiba (JP)

(72) Inventor: Norihiro OKAZAKI, Chiba (JP)

(73) Assignee: SEIKO INSTRUMENTS INC., Chiba (JP)

(21) Appl. No.: 14/132,016

(22) Filed: Dec. 18, 2013

(30) Foreign Application Priority Data
Dec. 28, 2012 (JP) 2012-288744

(51) Int. Cl. H02J 7/02

(52) U.S. Cl. CPC H02J 7/025
USPC 320/108

(57) ABSTRACT

An electronic component includes: a switching element to be connected to a resonant circuit, the resonant circuit including a power receiving coil to be supplied with power from a power feeding coil and a resonant capacitor configured to resonate with the power receiving coil, in which the switching element is to be connected in parallel to the power receiving coil together with the resonant capacitor and connected in series to the resonant capacitor; a transistor to be connected in series to a battery that is charged by DC power obtained by the power receiving coil; a charge control section for controlling a current flowing through the transistor so that a charge current flowing through the battery matches with a given current value by setting the switching element to a non-conductive state when an output voltage of the battery is equal to or less than a given threshold voltage.

### BACKGROUND OF THE INVENTION

1. Field of the Invention

The present invention relates to an electronic component, a power receiving device, and a power feeding system.

2. Description of the Related Art

In recent years, there has been known a power feeding system for supplying electric power by wireless via electromagnetic induction or electromagnetic coupling between a power feeding coil and a power receiving coil, for example, in order to charge a battery included in electronic equipment such as a mobile phone terminal or a personal digital assistant (PDA). In such a power feeding system, a power receiving device on the receiving side includes a power receiving coil and a resonant capacitor that resonates with the power receiving coil, and, when an overcurrent flows, the power receiving device controls the resonant capacitor to be electrically disconnected in order to limit a current for charging a battery (see, for example, Japanese Patent Application Laid-open Nos. Hei 10-126968 and Hei 8-103028).

In the above-mentioned power receiving device, however, for example, when the battery is charged from the state in which the voltage is low due to overdischarge or the like, even if the resonant capacitor is controlled to be electrically disconnected from a resonant circuit, a voltage higher than the battery voltage may be supplied from the power receiving coil so that a large charge current continues to flow.

As described above, in the above-mentioned power feeding system, the battery cannot always be charged appropriately in accordance with the state of the battery.

### SUMMARY OF THE INVENTION

In order to solve the above-mentioned problem, according to one embodiment of the present invention, there is provided an electronic component, including: a switching element to be connected to a resonant circuit, the resonant circuit including a power receiving coil to be supplied with power from a power feeding coil and a resonant capacitor configured to resonate with the power receiving coil, in which the switching element is to be connected in parallel to the power receiving coil together with the resonant capacitor and connected in series to the resonant capacitor; a transistor to be connected in series to a battery that is charged by DC power obtained by rectifying electric power received by the power receiving coil; and a charge control section for controlling a current flowing through the transistor so that a charge current flowing through the battery matches with a given current value by setting the switching element to a non-conductive state when an output voltage of the battery is equal to or less than a given threshold voltage.

Further, in the electronic component according to one embodiment of the present invention, when the output voltage of the battery is higher than the given threshold voltage, the charge control section supplies the DC power to the battery by bypassing the transistor, and further, when the charge current is equal to or more than a given threshold current, the charge control section sets the switching element to the non-conductive state.

Further, in the electronic component according to one embodiment of the present invention, when the output voltage of the battery is higher than the given threshold voltage, the charge control section sets the transistor to a conductive state to stop controlling the current flowing through the transistor, and further, when the charge current is equal to or more than a given threshold current, the charge control section sets the switching element to the non-conductive state.

Further, in the electronic component according to one embodiment of the present invention, the charge control section includes: a first comparator section for comparing the output voltage of the battery and the given threshold voltage to each other to output a result of the comparison; and a switching section for switching, based on the result of the comparison of the first comparator section, a charge mode between a first charge mode in which the output voltage of the battery is higher than the given threshold voltage and a second charge mode in which the output voltage of the battery is equal to or less than the given threshold voltage.

Further, in the electronic component according to one embodiment of the present invention, the charge control section includes: a voltage converter section for converting the charge current into a voltage; a second comparator section for comparing the voltage converted by the voltage converter section and a first threshold voltage corresponding to the given threshold current to each other to output a control signal for controlling the switching element to the non-conductive state when the converted voltage is equal to or more than the first threshold voltage; and a third comparator section for comparing the voltage converted by the voltage converter section and a second threshold voltage corresponding to the given current value to output a control signal for increasing a resistance of the transistor when the converted voltage is equal to or more than the second threshold voltage.

Further, in the electronic component according to one embodiment of the present invention: the given threshold current has a standard charge current value determined based on a discharge characteristic of the battery; and the given current value is a pre-charge current value determined to be smaller than the standard charge current value.

Further, according to one embodiment of the present invention, there is provided a power receiving device, including: the electronic component; a resonant circuit including a power receiving coil and a resonant capacitor; a rectifier section for rectifying electric power received by the power receiving coil to convert the electric power into DC power; and a battery to be charged by the DC power converted by the rectifier section.

Further, according to one embodiment of the present invention, there is provided a power feeding system including: the power receiving device; and a power feeding device including a power feeding coil arranged to be opposed to a power receiving coil.

According to the present invention, it is possible to appropriately charge a battery in accordance with the state of the battery.

### BRIEF DESCRIPTION OF THE DRAWINGS

In the accompanying drawings:

FIG. 1 is a schematic block diagram illustrating an exemplary power feeding system according to a first embodiment of the present invention;

FIG. 2 is a flowchart illustrating charge mode switching processing according to the first embodiment;

FIG. 3 is a graph showing an exemplary relationship between charge mode switching and a charge voltage and a charge current according to the first embodiment;

FIG. 4 is a timing chart illustrating an exemplary operation of a power receiving device according to the first embodiment;

FIG. 5 is a graph showing an exemplary relationship between the charge voltage and the charge current according to the first embodiment; and

FIG. 6 is a schematic block diagram illustrating an exemplary power feeding system according to a second embodiment of the present invention.

### DETAILED DESCRIPTION OF THE PREFERRED EMBODIMENTS

Now, a power feeding system according to one embodiment of the present invention is described below with reference to the accompanying drawings.

### First Embodiment

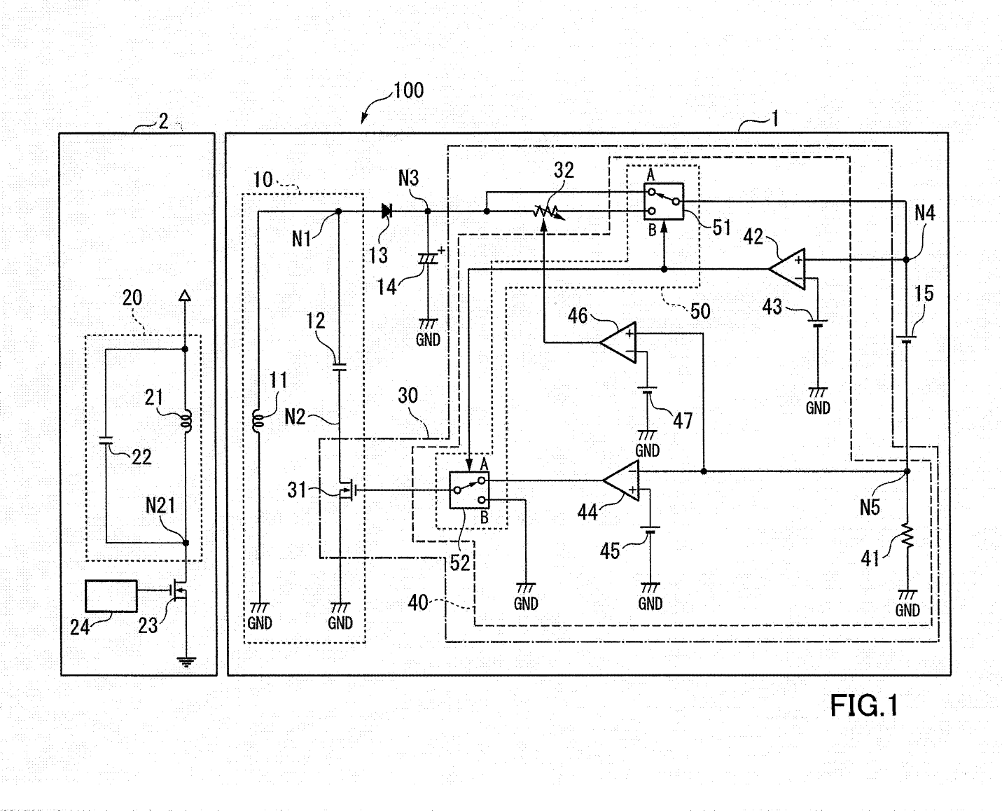

FIG. 1 is a schematic block diagram illustrating an exemplary power feeding system 100 according to a first embodiment of the present invention.

Referring to FIG. 1, the power feeding system 100 includes a power feeding device 2 and a power receiving device 1.

The power feeding system 100 is a system for supplying electric power from the power feeding device 2 to the power receiving device 1 by wireless (in a contactless manner). For example, the power feeding system 100 supplies electric power for charging a battery 15 included in the power receiving device 1 from the power feeding device 2 to the power receiving device 1. The power receiving device 1 is, for example, electronic equipment such as a mobile phone terminal or a PDA. The power feeding device 2 is, for example, a charger compatible with the power receiving device 1.

The power feeding device 2 includes a power feeding coil 21, a resonant capacitor 22, a drive transistor 23, and an oscillation circuit 24.

The power feeding coil 21 has a first terminal connected to a power source VCC and a second terminal connected to a node N21. The power feeding coil 21 supplies electric power to a power receiving coil 11 included in the power receiving device 1 by, for example, electromagnetic induction or electromagnetic coupling. For charging the battery 15, the power feeding coil 21 is arranged to be opposed to the power receiving coil 11 to supply power to the power receiving coil 11 by electromagnetic induction.

The resonant capacitor 22 is connected in parallel to the power feeding coil 21, and resonates with the power feeding coil 21. The power feeding coil 21 and the resonant capacitor 22 construct a resonant circuit 20. The resonant circuit 20 resonates at a given resonant frequency (for example, 100 kHz (kilohertz)) determined by an inductance value of the power feeding coil 21 and a capacitance value of the resonant capacitor 22.

The drive transistor 23 is, for example, a field effect transistor (FET transistor), and is connected in series to the resonant circuit 20. In this embodiment, the case where the drive transistor 23 is an N-channel metal oxide semiconductor (MOS) FET is described below as an example. In the following, “MOSFET” sometimes refers to a MOS transistor, and “N-channel MOS transistor” sometimes refers to an NMOS transistor.

The drive transistor 23 has a source terminal connected to the ground, a gate terminal connected to an output signal line of the oscillation circuit 24, and a drain terminal connected to the node N21. The drive transistor 23 periodically repeats an ON state (conductive state) and an OFF state (non-conductive state) in response to the output of the oscillation circuit 24. In this manner, a periodic signal is generated in the power feeding coil 21, and power is supplied from the power feeding coil 21 to the power receiving coil 11 by electromagnetic induction.

The oscillation circuit 24 outputs a control signal for controlling the drive transistor 23 to the ON state (conductive state) and the OFF state (non-conductive state) at a given period.

The power receiving device 1 includes a power receiving coil 11, a resonant capacitor 12, a rectifier diode 13, a smoothing capacitor 14, the battery 15, and an electronic component 30.

The power receiving coil 11 has a first terminal connected to a node N1 and a second terminal connected to the power source GND. The power receiving coil 11 is supplied with electric power from the power feeding coil 21 included in the power feeding device 2 by, for example, electromagnetic induction or electromagnetic coupling. For charging the battery 15, the power receiving coil 11 is arranged to be opposed to the power feeding coil 21.

The resonant capacitor 12 is connected in parallel to the power receiving coil 11, and resonates with the power receiving coil 11. The resonant capacitor 12 is connected between the node N1 and a node N2. The power receiving coil 11 and the resonant capacitor 12 construct a resonant circuit 10. The resonant circuit 10 resonates at a given resonant frequency (for example, 100 kHz) determined by an inductance value of the power receiving coil 11 and a capacitance value of the resonant capacitor 12. In this embodiment, the resonant frequency of the power receiving device 1 and the resonant frequency of the power feeding device 2 are equal to each other, for example, 100 kHz.

The rectifier diode 13 (rectifier section) has an anode terminal connected to the node N1 corresponding to one terminal of the power receiving coil 11 and a cathode terminal connected to a node N3 corresponding to one terminal of the smoothing capacitor 14. The rectifier diode 13 rectifies electric power received by the power receiving coil 11 to convert the electric power into DC power. In other words, the rectifier diode 13 converts AC power (AC voltage) generated in the power receiving coil 11 into DC power (DC voltage), thereby supplying the battery 15 with electric power for charging.

The smoothing capacitor 14 smooths the DC power converted by the rectifier diode 13.

The battery 15 is, for example, a storage battery or a secondary battery. The battery 15 is charged by the DC voltage rectified by the rectifier diode 13. In other words, the battery 15 is charged by the DC power obtained by rectifying the electric power received by the power receiving coil 11.

The electronic component 30 is, for example, a component such as an integrated circuit (IC). The electronic component 30 may be a module including a plurality of components such as ICs. The electronic component 30 includes a transistor 31, a dropper control transistor 32, and a charge control section 40.

The transistor 31 (switching element) is a switching element connected to the resonant circuit 10, and is connected in parallel to the power receiving coil 11 together with the resonant capacitor 12 and connected in series to the resonant capacitor 12. The transistor 31 is, for example, an NMOS transistor, and has a source terminal connected to the power source GND and a drain terminal connected to the node N2. The transistor 31 has a gate terminal connected to an output signal line from the charge control section 40 to be described later. When the transistor 31 is controlled to the ON state by the charge control section 40, the resonant capacitor 12 functions to generate resonation in the resonant circuit 10. When the transistor 31 is controlled to the OFF state by the charge control section 40, the resonant capacitor 12 is electrically disconnected to stop the resonation of the resonant circuit 10.

The dropper control transistor 32 is a transistor connected in series to the battery 15 via a switch part 51 to be described later. The dropper control transistor 32 is, for example, a MOS transistor or a bipolar transistor. The dropper control transistor 32 controls a charge current to be supplied to the battery 15 based on a control signal supplied from the charge control section 40. For example, in a pre-charge mode to be described later, the dropper control transistor 32 limits the charge current to a current value of about 1/10 C to about 1/20 C.

Symbol “C” is a unit of current value, where 1 C represents that the capacity of a nominal capacity value of the battery 15 is completely discharged by a constant current in 1 hour. In this embodiment, the case where the nominal capacity value of the battery 15 is, for example, 200 mAh (milliampere-hour) and 1 C is 200 mA is described as an example.

For example, when an output voltage of the battery 15 (charged battery terminal voltage of the battery 15) is equal to or less than 3.0 V (equal to or less than a given threshold voltage), the charge control section 40 switches the charge mode to the pre-charge mode (second charge mode) and controls the dropper control transistor 32 so that the charge current flowing through the battery 15 may be, for example, 10 mA ( 1/20 C). For example, when the output voltage of the battery 15 is higher than 3.0 V, the charge control section 40 switches the charge mode to a constant current charge mode (first charge mode) and controls the transistor 31 so that the charge current flowing through the battery 15 may be, for example, 100 mA (0.5 C).

In other words, when the output voltage of the battery 15 is equal to or less than 3.0 V, the charge control section 40 sets the transistor 31 to the OFF state and controls the current flowing through the dropper control transistor 32 so that the charge current flowing through the battery 15 may match with 10 mA ( 1/20 C).

When the output voltage of the battery 15 is higher than 3.0 V, the charge control section 40 supplies DC power to the battery 15 by bypassing the dropper control transistor 32. In this case, when the charge current is equal to or more than 10 mA, the charge control section 40 further sets the transistor 31 to the OFF state, or alternatively, when the charge current is less than 10 mA, the charge control section 40 further sets the transistor 31 to the ON state.

The specific configuration of the charge control section 40 is described below.

The charge control section 40 includes a resistor 41, comparators (42, 44), an operational amplifier 46, reference power sources (43, 45, 47), and a switching section 50.

The resistor 41 is connected between a node N5 connected to a cathode terminal (negative (minus) terminal) of the battery 15, and the power source GND. The resistor 41 corresponds to a voltage converter section for converting the charge current into a voltage. The resistor 41 outputs a change in charge current of the battery 15 to the node N5 as a change in voltage. The battery 15 is connected in series to the resistor 41, and has an anode terminal (positive (plus) terminal) connected to a node N4 connected to an output terminal of the switch part 51 of the switching section 50, and a cathode terminal (negative terminal) connected to the node N5.

The comparator 42 (first comparator section) compares the output voltage of the battery 15 and a given threshold voltage (for example, 3.0 V) to each other, and outputs a result of the comparison to the switching section 50. The comparator 42 has a positive input terminal connected to the node N4 and a negative input terminal connected to the reference power source 43. The voltage at the node N4 corresponds to the output voltage (charged battery terminal voltage) of the battery 15. The reference power source 43 is, for example, a constant voltage source for outputting 3.0 V.

Specifically, when the output voltage of the battery 15 is equal to or less than 3.0 V, the comparator 42 outputs an L state (Low state) to its output terminal. When the output voltage of the battery 15 is higher than 3.0 V, the comparator 42 outputs an H state (High state) to its output terminal.

Based on the result of the comparison of the comparator 42, the switching section 50 switches the charge mode between the constant current charge mode in which the output voltage of the battery 15 is higher than 3.0 V and the pre-charge mode in which the output voltage of the battery 15 is equal to or less than 3.0 V. Specifically, the switching section 50 switches the charge mode to the constant current charge mode, for example, when the output of the comparator 42 is in the H state. The switching section 50 switches the charge mode to the pre-charge mode, for example, when the output of the comparator 42 is in the L state.

The switching section 50 includes switch parts (51, 52).

The switch part 51 has a terminal A connected to the node N3 and a terminal B connected to an output terminal of the dropper control transistor 32, and establishes conduction between any one of the terminal A and the terminal B and the node N4 in accordance with the output of the comparator 42. When the output of the comparator 42 is in the H state, the switch part 51 connects the terminal A (node N3) to the node N4, thereby supplying the DC power rectified by the rectifier diode 13 to the anode terminal of the battery 15 by bypassing the dropper control transistor 32. When the output of the comparator 42 is in the L state, the switch part 51 connects the terminal B to the node N4, thereby supplying the DC power rectified by the rectifier diode 13 to the anode terminal of the battery 15 via the dropper control transistor 32.

The switch part 52 has a terminal A connected to an output terminal of the comparator 44 and a terminal B connected to the power source GND, and establishes conduction between any one of the terminal A and the terminal B and the gate terminal of the transistor 31 in accordance with the output of the comparator 42. When the output of the comparator 42 is in the H state, the switch part 52 connects the terminal A to the gate terminal of the transistor 31, thereby supplying the output of the comparator 44 to the gate terminal of the transistor 31. In this case, the transistor 31 becomes any one of the OFF state and the ON state in accordance with the output of the comparator 44.

When the output of the comparator 42 is in the L state, the switch part 52 connects the terminal B to the gate terminal of the transistor 31, thereby supplying the power GND to the gate terminal of the transistor 31. In this case, the transistor 31 becomes the OFF state, and hence the resonant capacitor 12 is electrically disconnected and does not function (disabled state).

The state in which the terminals A of the switch part 51 and the switch part 52 are selected corresponds to the constant current charge mode, and the state in which the terminals B of the switch part 51 and the switch part 52 are selected corresponds to the pre-charge mode.

The constant current charge mode is a mode for charging the battery 15 by bypassing the dropper control transistor 32. In the constant current charge mode, the battery 15 is charged by a constant current of 100 mA (0.5 C) in a manner that the OFF state and the ON state of the transistor 31 are switched in accordance with the output of the comparator 44.

The pre-charge mode is a mode for charging the battery 15 via the dropper control transistor 32 in the state in which the transistor 31 is turned OFF and the resonant capacitor 12 is disabled. In the pre-charge mode, the battery 15 is charged by a current of 10 mA ( 1/20 C) in a manner that the resistance across the dropper control transistor 32 is varied in accordance with the output of the operational amplifier 46.

The comparator 44 (second comparator section) compares a voltage converted by the resistor 41 and an output voltage of the reference power source 45 to each other. When the converted voltage is equal to or more than the output voltage of the reference power source 45, the comparator 44 outputs a control signal for controlling the transistor 31 to the OFF state to the switch part 52. The comparator 44 has a positive input terminal connected to the reference power source 45 and a negative input terminal connected to the node N5. The voltage at the node N5 corresponds to the charge current of the battery 15.

The reference power source 45 is a constant voltage source for outputting a first threshold voltage corresponding to a given threshold current (for example, 100 mA).

Specifically, when the voltage converted by the resistor 41 is lower than the first threshold voltage, the comparator 44 outputs the H state to its output terminal. When the voltage converted by the resistor 41 is equal to or more than the first threshold voltage, the comparator 44 outputs the L state to its output terminal.

The first threshold voltage output from the reference power source 45 is calculated by Expression (1).

“first threshold voltage”=“standard charge current value”×“resistance value of resistor 41” (1)

The standard charge current value is determined based on discharge characteristics (for example, nominal capacity value) of the battery 15, and is, for example, 100 mA (0.5 C) in this embodiment.

The operational amplifier 46 (third comparator section) compares the voltage converted by the resistor 41 and an output voltage of the reference power source 47 to each other. When the converted voltage is equal to or more than the output voltage of the reference power source 47, the operational amplifier 46 outputs a control signal for increasing the resistance value across the dropper control transistor 32 to the dropper control transistor 32. In other words, when the converted voltage is equal to or more than the output voltage of the reference power source 47, the operational amplifier 46 outputs a control signal for increasing the resistance of the dropper control transistor 32 to the dropper control transistor 32. The operational amplifier 46 has a positive input terminal connected to the node N5 and a negative input terminal connected to the reference power source 47.

The reference power source 47 is a constant voltage source for outputting a second threshold voltage corresponding to a given current value (for example, 10 mA).

Specifically, when the voltage converted by the resistor 41 is equal to or more than the second threshold voltage, the operational amplifier 46 increases the voltage at its output terminal. When the voltage converted by the resistor 41 is lower than the second threshold voltage, the operational amplifier 46 outputs the L state to its output terminal.

The resistance across the dropper control transistor 32 increases when the output terminal voltage of the operational amplifier 46 increases, and decreases when the output terminal voltage of the operational amplifier 46 drops. With this configuration, the dropper control transistor 32 can perform finer current control as compared to switching control.

The second threshold voltage output from the reference power source 47 is calculated by Expression (2).

“second threshold voltage”=“pre-charge current value”×“resistance value of resistor 41” (2)

The pre-charge current value is determined to be smaller than the above-mentioned standard charge current value, and is, for example, 10 mA ( 1/20 C) in this embodiment.

Next, the operation of the power feeding system 100 according to this embodiment is described below.

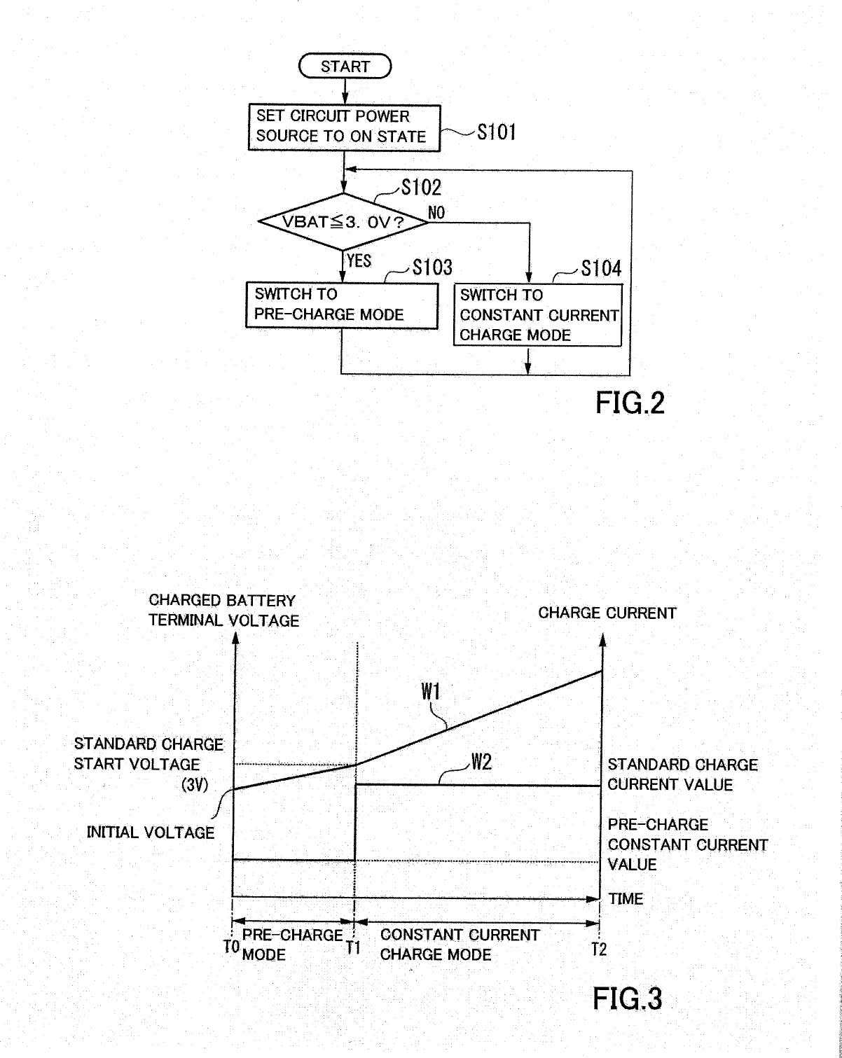

First, the operation of the power receiving device 1 included in the power feeding system 100 is described with reference to FIG. 2.

FIG. 2 is a flowchart illustrating charge mode switching processing according to this embodiment.

In FIG. 2, the power receiving device 1 first sets the circuit power source to the ON state (powered-ON state) (Step S101). For example, electric power is supplied from the power feeding coil 21 of the power feeding device 2 to the power receiving coil 11 of the power receiving device 1 by wireless (in a contactless manner), and the battery 15 is supplied with the electric power.

Next, the power receiving device 1 determines whether or not an output voltage (VBAT) of the battery 15 is equal to or less than 3.0 V (Step S102). When the output voltage (VBAT) of the battery 15 is equal to or less than 3.0 V, the charge control section 40 switches the charge mode to the pre-charge mode (Step S103). When the output voltage (VBAT) of the battery 15 is higher than 3.0 V, the charge control section 40 switches the charge mode to the constant current charge mode (Step S104).

Specifically, when the output voltage (VBAT) of the battery 15 is equal to or less than 3.0 V, the comparator 42 of the charge control section 40 outputs the L state to switch the switching section 50 (switch part 51 and switch part 52) to the state of the terminal B. In this manner, the battery 15 is charged in the pre-charge mode.

When the output voltage (VBAT) of the battery 15 is higher than 3.0 V, the comparator 42 outputs the H state to switch the switching section 50 (switch part 51 and switch part 52) to the state of the terminal A. In this manner, the battery 15 is charged in the constant current charge mode.

Subsequently, the flow returns to the processing of Step S102, and the charge mode switching processing of Step S102 to Step S104 is repeated.

FIG. 3 is a graph showing an exemplary relationship between the charge mode switching and the charge voltage and charge current according to this embodiment.

In FIG. 3, the left vertical axis represents the output voltage (charged battery terminal voltage) of the battery 15, and the right vertical axis represents the charge current. The horizontal axis represents time (charge time).

FIG. 3 shows an example where the output voltage of the battery 15 in the initial state before charging is equal to or less than 3.0V. In FIG. 3, a waveform W1 represents a change in output voltage of the battery 15, and a waveform W2 represents the charge current of the battery 15.

At a time T0, the initial voltage of the battery 15 is equal to or less than 3.0 V, and hence the comparator 42 of the charge control section 40 outputs the L state to switch the charge mode to the pre-charge mode. In other words, the switch part 52 of the switching section 50 is switched to the input of the terminal B, and the L state is output to the gate terminal of the transistor 31. In response thereto, the transistor 31 becomes the OFF state to disable the resonant capacitor 12, and hence the voltage generated in the power receiving coil 11 decreases.

In addition, the switch part 51 is switched to the input of the terminal B, and the charge voltage is supplied to the battery 15 via the dropper control transistor 32. At this time, the operational amplifier 46 compares the voltage converted by the resistor 41 and the output voltage of the reference power source 47 to each other. When the converted voltage is equal to or more than the output voltage of the reference power source 47, the operational amplifier 46 outputs a control signal for increasing the resistance across the dropper control transistor 32 to the dropper control transistor 32. With this configuration, the charge control section 40 controls the charge current of the battery 15 to be 10 mA in the pre-charge mode. As a result, the battery 15 is charged by a charge current smaller than the standard charge current value as indicated by the waveform W2, and the output voltage gradually increases as indicated by the waveform W1.

Next, at a time T1, when the output voltage of the battery 15 becomes larger than 3.0 V, the comparator 42 outputs the H state to change the pre-charge mode to the constant current charge mode. In other words, the switch part 52 of the switching section 50 is switched to the input of the terminal A, and the output of the comparator 44 is supplied to the gate terminal of the transistor 31. The switch part 51 is switched to the input of the terminal A, and the charge voltage is supplied to the battery 15 by bypassing the dropper control transistor 32.

In this case, when the charge current is equal to or more than 100 mA (standard charge current value), the comparator 44 outputs the L state to the gate terminal of the transistor 31 to set the transistor 31 to the OFF state. When the charge current is lower than 100 mA, the comparator 44 outputs the H state to the gate terminal of the transistor 31 to set the transistor 31 to the ON state. With this configuration, the charge control section 40 limits the voltage generated in the power receiving coil 11 so that the charge current may become the standard charge current value in the constant current charge mode.

As a result, during the period from the time T1 to a time T2, the battery 15 is charged with a charge current having the standard charge current value as indicated by the waveform W2, and the output voltage increases with a larger slope than that in the pre-charge mode as indicated by the waveform W1.

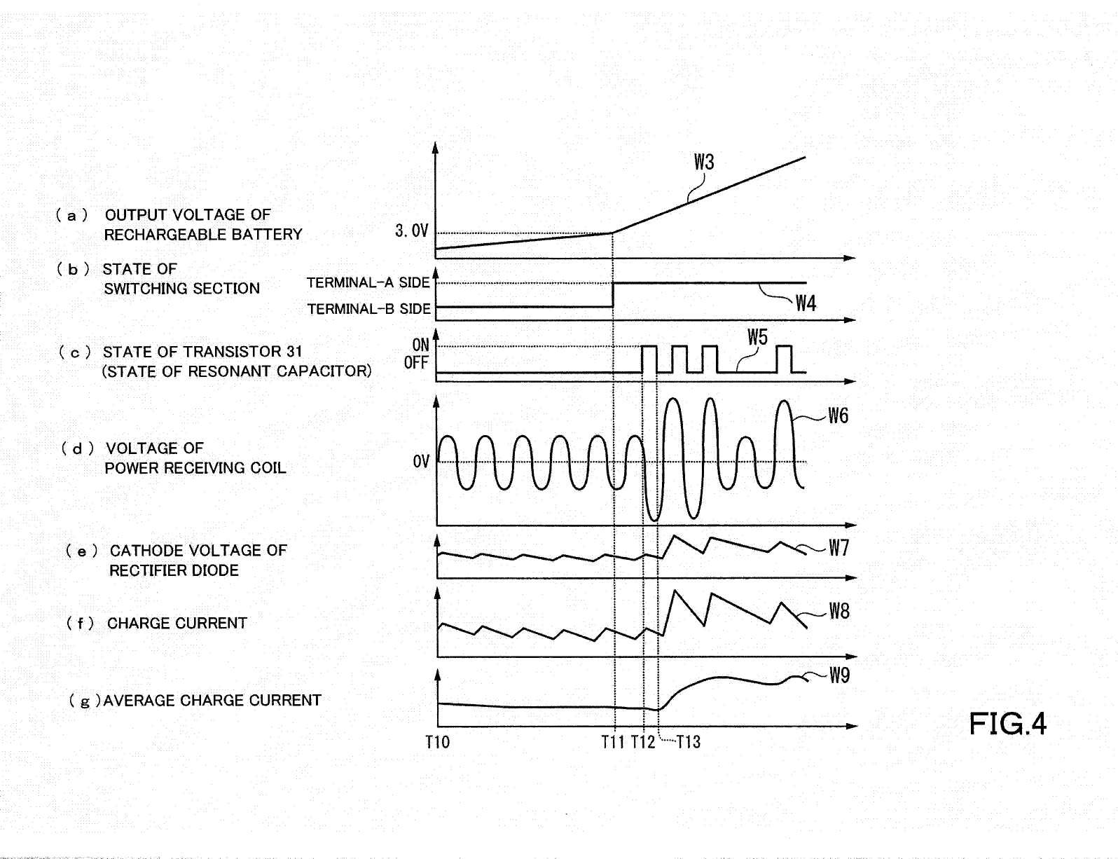

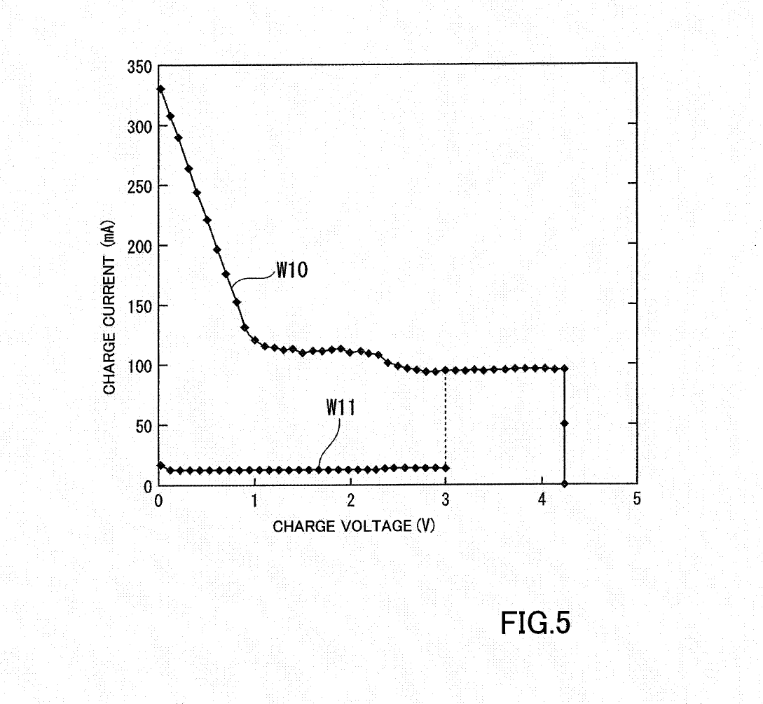

Next, the operation of the power receiving device 1 is described in detail with reference to FIG. 4.

FIG. 4 is a timing chart illustrating an exemplary operation of the power receiving device 1 according to this embodiment.

In FIG. 4, waveforms W3 to W9 represent in order from the top the waveforms of (a) the output voltage of the battery 15 (voltage at the node N4), (b) the state of the switching section 50, (c) the state of the transistor 31, (d) the voltage of the power receiving coil 11, (e) the cathode voltage of the rectifier diode 13, (f) the charge current, and (g) an average charge current. The vertical axes of the respective waveforms represent the voltage in (a), (d), and (e), the state of the terminal-A side/terminal-B side in (b), the conductive (ON)/non-conductive (OFF) state in (c), and the current in (f) and (g). The horizontal axis represents time.

From a time T10 to a time T11, the output voltage of the battery 15 is equal to or less than 3.0 V, and hence the comparator 42 of the charge control section 40 outputs the L state to switch the charge mode to the pre-charge mode. Thus, the switching section 50 is switched to the terminal-B side (input of the terminal B) as indicated by the waveform W4, and the state of the transistor 31 becomes the OFF state. In other words, the resonant capacitor 12 is disabled. In response thereto, the voltage of the power receiving coil 11 decreases as indicated by the waveform W6 because the resonant circuit 10 does not function. As a result, the cathode voltage of the rectifier diode 13 decreases as indicated by the waveform W7 as compared with the case where the resonant circuit 10 functions.

At this time, the operational amplifier 46 compares the voltage converted by the resistor 41 and the output voltage of the reference power source 47 to each other. When the converted voltage is equal to or more than the output voltage of the reference power source 47, the operational amplifier 46 increases the resistance across the dropper control transistor 32 to limit the charge current to be smaller. With this configuration, the charge control section 40 controls the charge current of the battery 15 to be 10 mA in the pre-charge mode. As a result, as indicated by the waveform W8 and the waveform W9, the charge control section 40 charges the battery 15 by a charge current controlled to be a constant current and be smaller than the standard charge current in the pre-charge mode.

At the time T11, when the output voltage of the battery 15 reaches 3.0 V, the comparator 42 of the charge control section 40 outputs the H state to switch the charge mode to the constant current charge mode. Thus, the switching section 50 is switched to the terminal-A side (input of the terminal-A) as indicated by the waveform W4, and after the time T11, the state of the transistor 31 becomes the ON state. In other words, the resonant capacitor 12 functions. In this case, when the charge current is lower than 100 mA, the comparator 44 outputs the H state to the gate terminal of the transistor 31 to set the transistor 31 to the ON state. When the charge current is equal to or more than 100 mA (standard charge current value), the comparator 44 outputs the L state to the gate terminal of the transistor 31 to set the transistor 31 to the OFF state. With this configuration, the charge control section 40 limits the voltage generated in the power receiving coil 11 so that the charge current may become the standard charge current value in the constant current charge mode.

The switch part 51 of the switching section 50 bypasses the dropper control transistor 32, and the above-mentioned function of limiting the charge current by the dropper control transistor 32 is disabled.

For example, from the time T11 to a time T12, the charge current is equal to or more than 100 mA (standard charge current value), and hence the comparator 44 outputs the L state to the gate terminal of the transistor 31 to set the transistor 31 to the OFF state. From the time T12 to a time T13, the charge current is smaller than 100 mA (standard charge current value), and hence the comparator 44 outputs the H state to the gate terminal of the transistor 31 to set the transistor 31 to the ON state.

In this manner, the charge control section 40 controls the transistor 31 as indicated by the waveform W5 so that the charge current may become the standard charge current value. As a result, the voltage of the power receiving coil 11 becomes larger than in the pre-charge mode. As indicated by the waveform W8 and the waveform W9, in the constant current charge mode, the charge control section 40 charges the battery 15 by a charge current controlled to be a constant current and be larger than in the pre-charge mode.

As described above, the electronic component 30 according to this embodiment includes the transistor 31, the dropper control transistor 32, and the charge control section 40. The transistor 31 is a switching element connected to the resonant circuit 10, and is connected in parallel to the power receiving coil 11 together with the resonant capacitor 12 and connected in series to the resonant capacitor 12. The resonant circuit 10 includes the power receiving coil 11 to be supplied with power from the power feeding coil 21, and the resonant capacitor 12 that resonates with the power receiving coil 11. The dropper control transistor 32 is connected in series to the battery 15 that is charged by DC power obtained by rectifying electric power received by the power receiving coil 11. Then, when the output voltage of the battery 15 is equal to or less than a given threshold voltage (for example, 3.0 V), the charge control section 40 sets the transistor 31 to the OFF state, and controls the current flowing through the dropper control transistor 32 so that the charge current flowing through the battery 15 may match with a given current value (for example, 10 mA).

With this configuration, the electronic component 30 according to this embodiment can reliably reduce the charge current flowing through the battery 15, for example, when the battery 15 is charged from the state in which the voltage is low due to overdischarge or the like. Consequently, the electronic component 30 according to this embodiment can appropriately charge the battery 15 in accordance with the state of the battery 15.

For example, FIG. 5 is a graph showing an exemplary relationship between the charge voltage (output voltage of the battery 15) and the charge current according to this embodiment.

In FIG. 5, the vertical axis represents the charge current flowing through the battery 15, and the horizontal axis represents the output voltage (charged battery terminal voltage) of the battery 15.

In FIG. 5, a waveform W10 represents a relationship between the output voltage of the battery 15 and the charge current in the case where the resonant capacitor 12 is electrically disconnected by, for example, the related art power feeding system described in Japanese Patent Application Laid-open No. Hei 10-126968 or Hei 8-103028. A waveform W11 represents a relationship between the output voltage of the battery 15 and the charge current in the case where the charge control section 40 according to this embodiment is applied.

As indicated by the waveform W10, in the related art power feeding system, when the output voltage of the battery 15 decreases from 3.0 V to about 1.0 V, the charge current gradually increases above the standard charge current value (100 mA). When the output voltage of the battery 15 further decreases to be equal to or less than 1.0 V, the charge current abruptly increases as indicated by the waveform W10. In other words, in the related art power feeding system, even when the resonant capacitor is controlled to be electrically disconnected from the resonant circuit, a large charge current may continue to flow. As described above, in the related art power feeding system described in Japanese Patent Application Laid-open No. Hei 10-126968 or Hei 8-103028, the charge current cannot be appropriately controlled, for example, when the battery 15 is charged from the state in which the output voltage of the battery 15 is low due to overdischarge or the like.

In contrast, the electronic component 30 according to this embodiment can appropriately control the charge current as indicated by the waveform W11, for example, even when the battery 15 is charged from the state in which the output voltage of the battery 15 is low due to overdischarge or the like. Because the electronic component 30 according to this embodiment can appropriately reduce the charge current, for example, even when the battery 15 is charged from the state in which the output voltage of the battery 15 is low due to overdischarge or the like, the deterioration of the battery 15, the power receiving coil 11, the rectifier diode 13, and the smoothing capacitor 14 can be reduced. Consequently, the electronic component 30 according to this embodiment can improve the life of the battery 15 and each circuit element and improve the reliability.

As indicated by the waveform W11, when the output voltage of the battery 15 is equal to or less than 3.0 V, the electronic component 30 according to this embodiment disables the resonant capacitor 12, and hence the voltage generated at the node N1 becomes lower and the voltage generated across the dropper control transistor 32 becomes lower. Besides, the charge current is limited by the dropper control transistor 32, and hence the dropper control transistor 32 generates a little heat loss. Consequently, the electronic component 30 according to this embodiment can reduce heat generation of the power receiving device 1. With this configuration, the electronic component 30 according to this embodiment can eliminate or reduce radiator components such as a heat sink for reducing the heat generation of the power receiving device 1, and hence high integration of components can be realized. In other words, the electronic component 30 according to this embodiment can simplify the configuration of the power receiving device 1, thus saving the space (downsizing) and reducing the weight.

In this embodiment, when the output voltage of the battery 15 is higher than a given threshold voltage (for example, 3.0 V), the charge control section 40 supplies DC power to the battery 15 by bypassing the dropper control transistor 32. Further, when the charge current is equal to or more than a given threshold current (for example, 100 mA), the charge control section 40 sets the transistor 31 to the OFF state.

With this configuration, when the output voltage of the battery 15 is higher than the given threshold voltage and when the charge current is equal to or more than the given threshold current, the electronic component 30 according to this embodiment disables the resonant capacitor 12 to control the charge current to be the given threshold current. Consequently, the electronic component 30 according to this embodiment can appropriately charge the battery 15, for example, even when the output voltage of the battery 15 is higher than a given threshold voltage.

In this embodiment, the charge control section 40 includes the comparator 42 and the switching section 50. The comparator 42 compares the output voltage of the battery 15 and a given threshold voltage (for example, 3.0 V) to each other, and outputs a result of the comparison. Based on the result of the comparison of the comparator 42, the switching section 50 switches the charge mode between the constant current charge mode (first charge mode) in which the output voltage of the battery 15 is higher than a given threshold voltage and the pre-charge mode (second charge mode) in which the output voltage of the battery 15 is equal to or less than the given threshold voltage.

Consequently, the electronic component 30 according to this embodiment can appropriately charge the battery 15 with a simple configuration.

In this embodiment, the charge control section 40 includes the resistor 41 for converting the charge current into a voltage, the comparator 44, and the operational amplifier 46. The comparator 44 compares the voltage converted by the resistor 41 and the first threshold voltage corresponding to the given threshold current (for example, 100 mA) to each other. When the converted voltage is equal to or more than the first threshold voltage, the comparator 44 outputs a control signal for controlling the transistor 31 to the OFF state. The operational amplifier 46 compares the voltage converted by the resistor 41 and the second threshold voltage corresponding to the given current value (for example, 10 mA) to each other. When the converted voltage is equal to or more than the second threshold voltage, the operational amplifier 46 outputs a control signal for increasing the resistance of the dropper control transistor 32.

Consequently, the electronic component 30 according to this embodiment can appropriately control the charge current of the battery 15 with a simple configuration.

In this embodiment, the given threshold current is the standard charge current value determined based on discharge characteristics (for example, nominal capacity value) of the battery 15, and the given current value is the pre-charge current value determined to be smaller than the standard charge current value.

Consequently, the electronic component 30 according to this embodiment can appropriately determine the charge current of the battery 15 and hence can appropriately charge the battery 15.

The power receiving device 1 according to this embodiment includes the electronic component 30, the resonant circuit 10 including the power receiving coil 11 and the resonant capacitor 12, the rectifier diode 13, and the battery 15. The rectifier diode 13 rectifies electric power received by the power receiving coil 11 to convert the electric power into DC power. The battery 15 is charged by the DC power converted by the rectifier diode 13. The power feeding system 100 according to this embodiment includes the power receiving device 1 and the power feeding device 2 including the power feeding coil 21 arranged to be opposed to the power receiving coil 11.

Consequently, the power receiving device 1 and the power feeding system 100 according to this embodiment exhibit the same effects as those of the above-mentioned electronic component 30, and hence can appropriately charge the battery 15.

Next, a second embodiment according to the present invention is described below with reference to the accompanying drawings.

### Second Embodiment

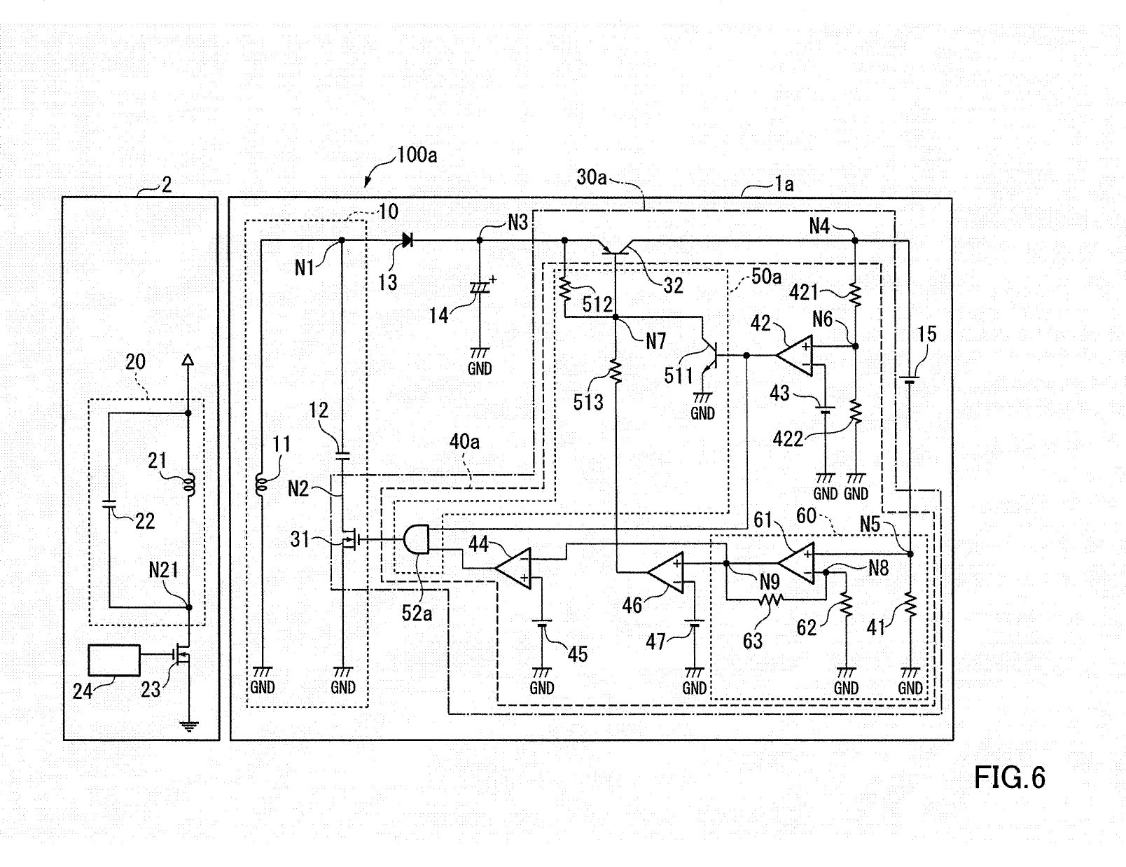

FIG. 6 is a schematic block diagram illustrating an exemplary power feeding system 100a according to the second embodiment of the present invention. In FIG. 6, the same configurations as in FIG. 1 are denoted by the same reference symbols, and descriptions thereof are omitted.

Referring to FIG. 6, the power feeding system 100a includes a power feeding device 2 and a power receiving device 1a.

The power feeding system 100a is a system for supplying electric power from the power feeding device 2 to the power receiving device 1a by wireless (in a contactless manner). For example, the power feeding system 100a supplies electric power for charging a battery 15 included in the power receiving device 1a from the power feeding device 2 to the power receiving device 1a.

The power receiving device 1a includes a power receiving coil 11, a resonant capacitor 12, a rectifier diode 13, a smoothing capacitor 14, the battery 15, and an electronic component 30a. The electronic component 30a includes a transistor 31, a dropper control transistor 32, and a charge control section 40a. The charge control section 40a includes resistors (421, 422), comparators (42, 44), an operational amplifier 46, reference power sources (43, 45, 47), a switching section 50a, and a voltage converter section 60.

This embodiment is different from the first embodiment in that the charge control section 40a includes the resistors (421, 422), the switching section 50a, and the voltage converter section 60. The different configurations are described below.

The resistors (421, 422) are connected in series between the node N4 and the power source GND, and convert the output voltage of the battery 15 by resistive voltage division into a given voltage level to be compared by the comparator 42. In this embodiment, the positive input terminal of the comparator 42 is connected to a node N6 to which the resistor 421 and the resistor 422 are connected. In this embodiment, the reference power source 43 is a constant voltage source for outputting a voltage corresponding to the case where a given threshold voltage (for example, 3.0 V) is divided at a resistance ratio of the resistor 421 and the resistor 422.

In this embodiment, the voltage obtained by resistive voltage division of the resistor 421 and the resistor 422 is used for the detection (comparison) of the output voltage of the battery 15, and hence the comparator 42 having a low withstand voltage can be used.

The switching section 50a includes a transistor 511, resistors (512, 513), and an AND circuit 52a. The transistor 511 and the resistors (512, 513) correspond to the switch part 51 according to the first embodiment, and the AND circuit 52a corresponds to the switch part 52 according to the first embodiment. In addition, the transistor 511 and the resistors (512, 513) have functions necessary for serving as the dropper control transistor 32 in the first embodiment.

This embodiment shows the case where a PNP bipolar transistor (hereinafter referred to as “PNP transistor”) is applied to the dropper control transistor 32 as an example.

The transistor 511 is, for example, an NPN bipolar transistor (hereinafter referred to as “NPN transistor”). The transistor 511 has a collector terminal connected to a node N7, a base terminal connected to an output signal line of the comparator 42, and an emitter terminal connected to the power source GND. When the output of the comparator 42 is in the H state (constant current charge mode), the transistor 511 becomes the ON state to supply the L state to a control terminal (base terminal) of the dropper control transistor 32. In response thereto, the dropper control transistor 32 becomes the ON state, and the charge current of the battery 15 becomes the same state as that controlled to the terminal-A side (constant current charge mode) of the switch part 51 in the first embodiment.

When the output of the comparator 42 is in the L state (pre-charge mode), the transistor 511 becomes the OFF state to enable the function of the dropper control transistor 32.

The resistor 512 has a first terminal connected to the node N3 and a second terminal connected to the node N7. The node N7 is connected to the base terminal of the dropper control transistor 32. The resistor 512 supplies the same voltage as that at the emitter terminal of the dropper control transistor 32 to the base terminal thereof in order to set the dropper control transistor 32 to the OFF state.

The resistor 513 has a first terminal connected to the node N7 and a second terminal connected to an output signal line of the operational amplifier 46. In the pre-charge mode, the operational amplifier 46 controls the dropper control transistor 32 via the resistor 513.

In this manner, the transistor 511 and the resistors (512, 513) function similarly to the switch part 51 according to the first embodiment.

The AND circuit 52a is an operational circuit that implements AND logical operation (logical conjunction) of two input signals. The AND circuit 52a has a first input terminal connected to an output signal line of the comparator 42 and a second input terminal connected to an output signal line of the comparator 44. The AND circuit 52a has an output terminal connected to the gate terminal of the transistor 31. In other words, when the output of the comparator 42 is in the H state (constant current charge mode), the AND circuit 52a outputs the output of the comparator 44 to the gate terminal of the transistor 31. When the output of the comparator 42 is in the L state (pre-charge mode), the AND circuit 52a outputs the L state to the gate terminal of the transistor 31.

In this manner, the AND circuit 52a functions similarly to the switch part 52 according to the first embodiment.

The voltage converter section 60 includes a resistor 41, an operational amplifier 61, and resistors (62, 63), and converts the charge current into a voltage.

The operational amplifier 61 has a positive input terminal connected to the node N5 and a negative input terminal connected to a node N8. The operational amplifier 61 has an output terminal connected to a node N9 and also connected to a positive input terminal of the operational amplifier 46 and a negative input terminal of the comparator 44.

The resistor 62 is connected between the node N8 and the power source GND. The resistor 63 is connected between the node N8 and the node N9.

The operational amplifier 61 and the resistors (62, 63) construct an amplifier circuit. The amplifier circuit amplifies the voltage converted from the charge current by the resistor 41, and supplies the amplified voltage to the comparator 44 and the operational amplifier 46. With this configuration, the resistance value of the resistor 41 can be reduced, and hence the charge control section 40a can improve the detection accuracy of the charge current.

As described above, the electronic component 30a, the power receiving device 1a, and the power feeding system 100a according to this embodiment have the same functions as those in the first embodiment. Consequently, the electronic component 30a, the power receiving device 1a, and the power feeding system 100a according to this embodiment exhibit the same effects as those in the first embodiment.

In this embodiment, when the output voltage of the battery 15 is higher than a given threshold voltage (for example, 3.0 V), the charge control section 40a sets the dropper control transistor 32 to the ON state to stop controlling the current flowing through the dropper control transistor 32, and further, when the charge current is equal to or more than a given threshold current (for example, 100 mA), the charge control section 40a sets the transistor 31 to the OFF state.

With this configuration, when the output voltage of the battery 15 is higher than the given threshold voltage and when the charge current is equal to or more than the given threshold current, the electronic component 30a, the power receiving device 1a, and the power feeding system 100a according to this embodiment disable the resonant capacitor 12 to control the charge current to be the given threshold current. Consequently, the electronic component 30a, the power receiving device 1a, and the power feeding system 100a according to this embodiment can appropriately charge the battery 15, for example, even when the output voltage of the battery 15 is higher than the given threshold voltage.

Note that, the present invention is not limited to each of the above-mentioned embodiments, and may be changed within the range not departing from the concept of the present invention.

For example, in each of the above-mentioned embodiments, the electronic component 30 (30a) is configured not to include the resonant capacitor 12, the rectifier diode 13, and the smoothing capacitor 14, but the electronic component 30 (30a) may include the resonant capacitor 12, the rectifier diode 13, or the smoothing capacitor 14.

In each of the above-mentioned embodiments, the transistor 31 of the electronic component 30 (30a) uses an NMOS transistor as an example of the switching element, but may use another switching element. In the electronic component 30 (30a), for example, a P-channel MOS transistor (PMOS transistor) or a bipolar transistor may be applied to the transistor 31.

In the above-mentioned second embodiment, the dropper control transistor 32 of the electronic component 30a uses a PNP transistor, but another transistor such as an NPN transistor or a MOS transistor may be applied to the dropper control transistor 32.

In the above-mentioned second embodiment, the transistor 511 of the electronic component 30a uses an NPN transistor, but another transistor such as a PNP transistor or a MOS transistor may be applied to the transistor 511.

In each of the above-mentioned embodiments, the electronic component 30 (30a) is configured to detect the charge current by using the resistor 41, but may detect the charge current by using another method.

The electronic component 30 (30a) or each configuration included in the electronic component 30 (30a) may be implemented by dedicated hardware. The electronic component 30 (30a) or each configuration included in the electronic component 30 (30a) may be constructed by a memory and a CPU, and its functions may be implemented by loading a program for implementing the electronic component 30 (30a) or each configuration included in the electronic component 30 (30a) onto the memory and executing the program.

What is claimed is:

1. An electronic component, comprising:
a switching element to be connected to a resonant circuit, the resonant circuit comprising a power receiving coil to be supplied with power from a power feeding coil and a resonant capacitor configured to resonate with the power receiving coil, in which the switching element is to be connected in parallel to the power receiving coil together with the resonant capacitor and connected in series to the resonant capacitor;
a transistor to be connected in series to a battery that is charged by DC power obtained by rectifying electric power received by the power receiving coil; and
a charge control section for controlling a current flowing through the transistor so that a charge current flowing through the battery matches with a given current value by setting the switching element to a non-conductive state when an output voltage of the battery is equal to or less than a given threshold voltage.

2. An electronic component according to claim 1, wherein, when the output voltage of the battery is higher than the given threshold voltage, the charge control section supplies the DC power to the battery by bypassing the transistor, and further, when the charge current is equal to or more than a given threshold current, the charge control section sets the switching element to the non-conductive state.

3. An electronic component according to claim 1, wherein, when the output voltage of the battery is higher than the given threshold voltage, the charge control section sets the transistor to a conductive state to stop controlling the current flowing through the transistor, and further, when the charge current is equal to or more than a given threshold current, the charge control section sets the switching element to the non-conductive state.

4. An electronic component according to claim 2, wherein the charge control section comprises:
a first comparator section for comparing the output voltage of the battery and the given threshold voltage to each other to output a result of the comparison; and
a switching section for switching, based on the result of the comparison of the first comparator section, a charge mode between a first charge mode in which the output voltage of the battery is higher than the given threshold voltage and a second charge mode in which the output voltage of the battery is equal to or less than the given threshold voltage.

5. An electronic component according to claim 3, wherein the charge control section comprises:
a first comparator section for comparing the output voltage of the battery and the given threshold voltage to each other to output a result of the comparison; and
a switching section for switching, based on the result of the comparison of the first comparator section, a charge mode between a first charge mode in which the output voltage of the battery is higher than the given threshold voltage and a second charge mode in which the output voltage of the battery is equal to or less than the given threshold voltage.

6. An electronic component according to claim. 2, wherein the charge control section comprises:
a voltage converter section for converting the charge current into a voltage;
a second comparator section for comparing the voltage converted by the voltage converter section and a first threshold voltage corresponding to the given threshold current to each other to output a control signal for controlling the switching element to the non-conductive state when the converted voltage is equal to or more than the first threshold voltage; and
a third comparator section for comparing the voltage converted by the voltage converter section and a second threshold voltage corresponding to the given current value to output a control signal for increasing a resistance of the transistor when the converted voltage is equal to or more than the second threshold voltage.

7. An electronic component according to claim 3, wherein the charge control section comprises:
a voltage converter section for converting the charge current into a voltage;
a second comparator section for comparing the voltage converted by the voltage converter section and a first threshold voltage corresponding to the given threshold current to each other to output a control signal for controlling the switching element to the non-conductive state when the converted voltage is equal to or more than the first threshold voltage; and
a third comparator section for comparing the voltage converted by the voltage converter section and a second threshold voltage corresponding to the given current value to output a control signal for increasing a resistance of the transistor when the converted voltage is equal to or more than the second threshold voltage.

8. An electronic component according to claim 4, wherein the charge control section comprises:
a voltage converter section for converting the charge current into a voltage;
a second comparator section for comparing the voltage converted by the voltage converter section and a first threshold voltage corresponding to the given threshold current to each other to output a control signal for controlling the switching element to the non-conductive state when the converted voltage is equal to or more than the first threshold voltage; and
a third comparator section for comparing the voltage converted by the voltage converter section and a second threshold voltage corresponding to the given current value to output a control signal for increasing a resistance of the transistor when the converted voltage is equal to or more than the second threshold voltage.

9. An electronic component according to claim 5, wherein the charge control section comprises:
a voltage converter section for converting the charge current into a voltage;
a second comparator section for comparing the voltage converted by the voltage converter section and a first threshold voltage corresponding to the given threshold current to each other to output a control signal for controlling the switching element to the non-conductive state when the converted voltage is equal to or more than the first threshold voltage; and
a third comparator section for comparing the voltage converted by the voltage converter section and a second threshold voltage corresponding to the given current value to output a control signal for increasing a resistance of the transistor when the converted voltage is equal to or more than the second threshold voltage.

10. An electronic component according to claim 2, wherein:
the given threshold current comprises a standard charge current value determined based on a discharge characteristic of the battery; and
the given current value comprises a pre-charge current value determined to be smaller than the standard charge current value.

11. An electronic component according to claim 3, wherein:
the given threshold current comprises a standard charge current value determined based on a discharge characteristic of the battery; and
the given current value comprises a pre-charge current value determined to be smaller than the standard charge current value.

12. An electronic component according to claim 4, wherein:
the given threshold current comprises a standard charge current value determined based on a discharge characteristic of the battery; and
the given current value comprises a pre-charge current value determined to be smaller than the standard charge current value.

13. An electronic component according to claim 5, wherein:
the given threshold current comprises a standard charge current value determined based on a discharge characteristic of the battery; and
the given current value comprises a pre-charge current value determined to be smaller than the standard charge current value.

14. An electronic component according to claim 6, wherein:
the given threshold current comprises a standard charge current value determined based on a discharge characteristic of the battery; and
the given current value comprises a pre-charge current value determined to be smaller than the standard charge current value.

15. An electronic component according to claim 7, wherein:
the given threshold current comprises a standard charge current value determined based on a discharge characteristic of the battery; and
the given current value comprises a pre-charge current value determined to be smaller than the standard charge current value.

16. An electronic component according to claim 8, wherein:
the given threshold current comprises a standard charge current value determined based on a discharge characteristic of the battery; and
the given current value comprises a pre-charge current value determined to be smaller than the standard charge current value.

17. An electronic component according to claim 9, wherein:
the given threshold current comprises a standard charge current value determined based on a discharge characteristic of the battery; and
the given current value comprises a pre-charge current value determined to be smaller than the standard charge current value.

18. A power receiving device, comprising:
the electronic component according to claim 1;
a resonant circuit comprising a power receiving coil and a resonant capacitor;
a rectifier section for rectifying electric power received by the power receiving coil to convert the electric power into DC power; and
a battery to be charged by the DC power converted by the rectifier section.

19. A power feeding system, comprising:
the power receiving device according to claim 18; and
a power feeding device comprising a power feeding coil arranged to be opposed to a power receiving coil.
